(19) United States
(12) Patent Application Publication
(10) Pub. No.: US 2018/0037273 A1
(43) Pub. Date: Feb. 8, 2018

(54) COMPOSITE SHEET MATERIAL USEFUL AS VEHICLE ROOF PANEL, AND METHOD OF ITS MANUFACTURE

(71) Applicant: Euramax Coated Products B.V., Roermond (NL)

(72) Inventors: Patrick Peter Mario Aarts, Roermond (NL); Marcel Henricus Mechtilda Verheijden, Roermond (NL)

(21) Appl. No.: 15/612,631

(22) Filed: Jun. 2, 2017

(30) Foreign Application Priority Data
Jun. 6, 2016 (NL) 2016897

(51) Int. Cl. B62D 29/04; B62D 25/06; B62D 25/02; B32B 5/02; B32B 27/30

(52) U.S. Cl. CPC B62D 29/043; B32B 5/028; B32B 27/30; B62D 25/02; B62D 25/06; B32B 2262/101; B32B 2309/105; B32B 2605/00; B32B 2367/00

(57) ABSTRACT

Composite sheet material (1) comprising a glass fiber reinforced thermoplastic substrate (3) having first and second sides, a reinforced film (23) on the first side of the glass fiber reinforced substrate (3), and a layer of paint (24) applied to an exposed surface of the reinforced film (23). The glass fiber reinforced thermoplastic substrate (3) has three layers (7, 9, 11) of wound glass fiber filaments (21) consolidated and fused in a thermoplastic resin matrix (22). The composite sheet material (1) is useful in obtaining hail-proof roof paneling.

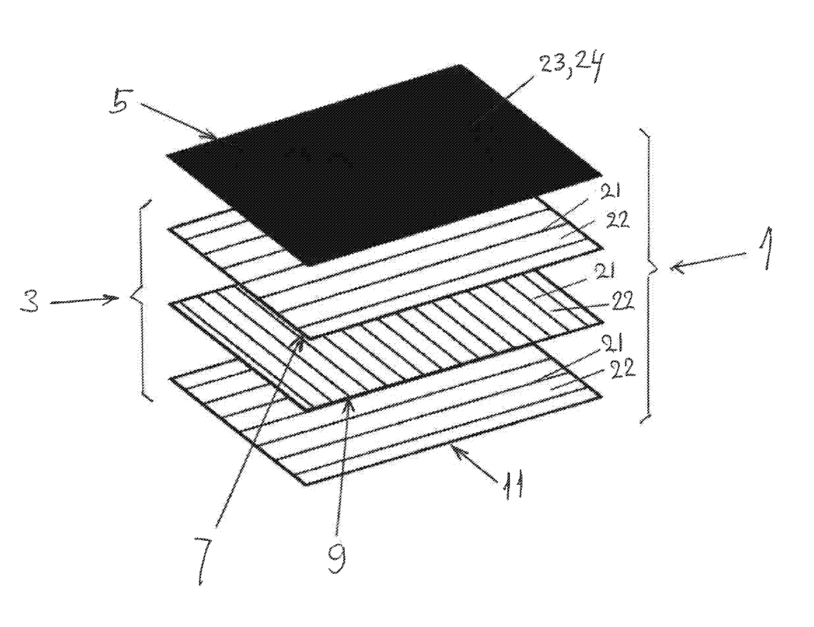

The invention relates to a surface-coated composite substrate, suitable for vehicle bodies, and in particular hail proof roofs.

Continuous paint coated aluminium sheeting has found widespread use as outer skin material in the manufacture of vehicle bodies, notably those of recreational vehicles such as caravans and motorhomes. By nature of their use in open air this kind of vehicle body has met with a relatively high exposure to hail often incurring damage. Such damage has been troubling insurance companies as well as discerning owners. Some relief was found in using non-metal material for the roofing sections of such recreational vehicles, by employing a glass fiber reinforced thermosetting resin sheeting. This glass fiber reinforced thermosetting resin sheeting has been difficult to color match with the coil coated aluminium side walls, and has shown increased deterioration upon weathering. While this has not impaired the effectiveness of this roof sheeting, this tendency of discoloring has frustrated at least some discerning owners of recreational vehicles and depreciated their resale value. Apart from its discoloring this glass fiber reinforced thermosetting resin sheeting has also been difficult to process, i.e. routing and cutting due to the brittle nature of the thermosetting resin.

It is also known to use composite substrates in bodies of cargo trailers, such as an example described in US 2014/0130657 that relates to cargo trailer roofs to which an additional surface coating may be applied as a means of UV-protection. In another example according to US 2014/0127451 a surface powder coating is employed. Document US 2014/0360344 relates to adding a PVDF to a thermoplastic laminate to increase fire retardancy.

None of this prior art has yet offered an attractive solution to the problem of replacing traditional roof paneling on caravans and motorhomes by a more hail proof sheet material while obtaining an optimal and durable match in appearance with surface painted aluminium sheet used on side walls.

Accordingly it is an object of the present invention to propose an improved composite sheet material useful as vehicle roof panel, and method for its manufacture. In a more general sense it is thus an object of the invention to overcome or reduce at least one of the disadvantages of the prior art. It is also an object of the present invention to provide alternative solutions which are less cumbersome in manufacture and operation and which moreover can be obtained relatively inexpensively. Alternatively it is an object of the invention to at least provide a useful alternative.

To this end the invention provides a composite sheet material and method of its manufacturing as defined in one or more of the appended claims. In particular the composite sheet material according to the invention comprises a glass fiber reinforced thermoplastic substrate having first and second sides, a reinforced film on the first side of the glass fiber reinforced substrate, and a layer of paint applied to an exposed surface of the reinforced film. Such sheet material is resistant to hail damage, and offers a homogenous surface that is suitable to receive and retain a layer of paint. In particular this composite sheet material is suitable for use as roof paneling in recreational vehicles and dwellings that have a relatively high exposure to hail.

The glass fiber reinforced thermoplastic substrate can have three layers of wound glass fiber filaments consolidated and fused in a thermoplastic resin matrix. In one embodiment the glass fiber filaments can be in a tensioned state. In another or the same embodiment the glass fiber filaments can be arranged next to one another. Additionally or alternatively the glass filaments can be continuous fibers in twisted yarns. Continuous fibers result in a limited coefficient of thermal expansion and best possible strength. In another or similar embodiment the continuous glass filaments can also be wound E-glass filaments.

For an optimal homogeneity of material properties, such as strength and expansion and contraction behavior, the layers of glass filaments are stacked in three crosswise plies. In this regard it is further advantageous when the glass filaments of the three crosswise plies are in a 0-90-0 degree cross-ply. The thermoplastic resin matrix can be a poly-ethylene terephthalate (PET), and advantageously the poly-ethylene terephthalate is a glycol-modified version (for example a PETG resin). Three reinforced layers of continuous glass fibers of wound E-glass filaments consolidated and fused in a three layer cross ply configuration embedded in a tough plastic binder provide optimum strength and impact resistance. Also the tough thermoplastic matrix will resist cracking and offers excellent screw fastness and fixation. The thermal expansion and contraction properties of this glass fiber reinforced thermoplastic substrate are closer to those of aluminium than what the thermoplastic matrix material would have offered without this glass fiber reinforcement. The thermal expansion and contraction of thermoplastic materials, such as PET resins, substantially exceed those of aluminium. The continuous wound E-glass filaments embedded in a cross ply configuration reduce the thermal expansion and contraction towards those of glass. The thus modified expansion and contraction properties allow the composite sheet material to be used in construction situations, where panels are enclosed at their perimeter, such as in the construction recreational vehicles and caravans. Also the reduced thermal expansion and contraction does allow the composite sheet material allow it to be combined with conventional lacquered aluminium sheet material in such recreational vehicle structures.

In one embodiment the reinforced film is a vinyl film. In perhaps a more advantageous embodiment the reinforced film is a PVC film having an embedded scrim fabric as reinforcing element. Advantageously the scrim fabric is then visible as a regular surface pattern on the exposed surface of the reinforced film. Such surface finish materials when applied to the glass fiber reinforced thermoplastic substrate have been found useful, because without the PVC surface finish film the adhesion of the coating if it would be directly applied to a PETG surface would not be good, and require primers or pre-treating. Another point is that the glass fiber reinforced thermoplastic substrate has inherent random surface imperfections (holes, folds and projecting glass fibers). These surface imperfections may not be removed by a lacquer coating, even if it had been successfully applied. The PVC surface finish film effectively also covers the surface imperfections of the glass fiber reinforced thermoplastic substrate. In this regard it has also been found that a suitable scrim material is helpful. The composition of the scrim determines effectiveness in removing visibility of any surface imperfections. Without a reinforcing scrim in the surface finish film surface imperfections, such as notably holes would still be visible. A product without this PVC surface finish film would thus not likely offer an alternative to the aesthetic applications for which this product has been developed. Hence the reinforced vinyl surface finish film, results in an acceptable surface for subsequent coating by paint or lacquer.

The layer of paint in one embodiment can be a durable UV-curing paint coating. In the same or another embodiment the layer of paint can have a coating thickness of 30 μm. Preferably the layer of paint is selected amongst durable top coatings with binder systems that closely resemble those used in continuous coil coating of aluminium strip.

According to the invention the method of manufacturing a composite sheet material can comprise at least the steps of providing a glass fiber reinforced thermoplastic substrate having first and second sides, applying a reinforced film on the first side of the glass fiber reinforced substrate, and applying paint to an exposed surface of the reinforced film. When the glass fiber reinforced thermoplastic substrate has a PETG binder matrix, and the reinforced film has a PVC binder matrix, the reinforced film can be thermally laminated directly to the glass fiber reinforced thermoplastic substrate. The obtained film covered substrate can be provided in a form of coatable coils for applying lacquer or paint in a coil coating process.

The obtained constructional sheet material is thin and lightweight, at about only 1.2 kilogram per square meter, and at a thickness of about 1 millimeter. It also offers price levels that are competitive to alternative, but less optimal, construction sheet materials.

A recreational vehicle or trailer (recreational or commercial) having the composite sheet material as set out hereinabove as an outer body panel, and preferably at least as a roof panel, is also within the scope of the present invention. The same applies to use of this composite material in the construction of hail-proof roof paneling.

Further advantageous aspects of the invention will become clear from the appended description and in reference to the accompanying drawing Figure, which shows the layers of a composite with a visible side that can directly receive a paint or a lacquer in an exploded arrangement.

### BRIEF DESCRIPTION OF THE DRAWING

The sole accompanying drawing Figure shows schematically the product build-up of the lacquered composite sheet material 1 of the invention. The individual layers are schematically shown in an exploded arrangement, and as a fragmentary portion of a composite sheet material that may have a continuous length suitable to be shipped in coils.

### DETAILED DESCRIPTION OF THE INVENTION

The individual layers of the composite sheet material 1 include a three-ply substrate 3, and a reinforced surface finish film 5, to which a paint layer is applied. The three-ply substrate 3 is composed of a first outer layer 7, an intermediate layer 9, and a second outer layer 11.

The three-ply substrate 3 contains a first component 21 in the form of a glass fiber reinforcement, and a second component 22 in the form of a thermoplastic resin matrix. The first component 21 is glass in an amount of 40,7% by weight of the finished composite sheet material according to the invention. The glass of the first component 21 is a long fiber thermoplastic fiber glass commercially available as TUFRov 4588 fiberglass yarn from PPG Fiber Glass. These glass fibers of the first component 21 are clustered and turned in length direction (fibers in twisted yarns). A plurality of these yarns are positioned next to each other in a tensioned state, and a second component 22, which is a PETG polymer (XTP1000 from Eastman Chemical Company), is extruded to encapsulate the tensioned yarns as an embedded structure. The result is a unidirectional (UD) tape of about 60 cm wide. The second component 22 (PETG) is present in an amount of 29,5% by weight in the finished composite sheet material of the invention, and is a glycol modified poly-ethylene terephthalate (XTP1000 from Eastman Chemical Company) thermoplastic matrix material that binds the reinforcing fibers together in the unidirectional tapes.

The resulting tapes are placed side by side and then stacked into crosswise plies forming the first outer layer 7, the intermediate layer 9, and the second outer layer 11. In this case there are three layers of tape stacked crosswise, in a 0-90-0 degrees arrangement. The tapes are then consolidated (fused together and pressed) in a teflon double belt press with heat (ca. 230 C). The first and second components 21 and 22 are thus consolidated and fused in a three layer cross ply to obtain a continuous three-ply fiber reinforced thermoplastic sheet material. Such a product having continuous fibers in twisted yarns, embedded in a PETG matrix in a 0-90-0 degree cross-ply can have a tape thickness of 0.3 to 0.5 mm (hence total thickness of 0.9 to 1.5 mm), and is commercially available under the trade designation PETG 5811 Tri-Ply from Polystrand, Inc., Englewood, Colo., USA.

The reinforced surface finish film 5, with applied paint layer is formed by a third component 23, which is a reinforced vinyl film, to which durable paint layer, being a fourth component 24, can be applied.

The third component 23 is represented as 26,8% by weight of vinyl in the finished composite sheet material of the invention. This vinyl film third component 23 is a frontlit banner (FR) material available from supplier Spandex under their designation ImagePerfect IP2128, and is used in the present application as a surface finish material. This commercially available scrim fabric reinforced PVC film material typically has a thickness of 410 μm, and a weight of 450 g/m². Its scrim fabric reinforcement is visible as a regular surface pattern.

The PVC film banner material (third component 23 Imageperfect IP2128) is thermally laminated (i.e. fused and compressed) to the PETG matrix of the consolidated and fused three layer cross ply substrate 3 (first and second components 21 and 22) using heat (ca. 170 C) in a teflon double belt press. Optionally a bonding agent can be used between confronting PVC and PET surfaces, but this is not essential. The poly-ethylene terephthalate-glycol modified thermoplastic matrix material 22 that binds the reinforcing fibers 21 together, also binds the surface finish film 23 to the three-ply glass fiber reinforced thermoplastic substrate 3. This results in a composite with a visible vinyl side that can directly receive a lacquer.

The fourth component 24 paint layer represents 2,9% by weight of the finished composite sheet material. A durable UV-curing paint coating that has been found suitable is available as FREODUR UVC 50536-2 from Emil Frei GmbH & Co. KG. The visible side of the vinyl film 23 is coated by roll with this FREODUR UVC 50536-62 (fourth component 24) without any pre-treatment, and cured in a UV station. This UV-curable pigmented paint is applied in a layer thickness of 30 μm.

Thereby the finished product, as an aesthetic and durable lacquered composite continuous sheet, is obtained. Thereby the first to fourth components (reference numerals 21 to 24 in the drawing Figure) are the fundamental constituents of the finished product. No glue layers, bonding layers and/or primers are used in this production process.

Without the PVC surface finish film the adhesion of paint or lacquer if it would be directly applied to the PETG surface would require use of primers or pre-treating. The fiber reinforced thermoplastic material also has inherent random surface imperfections (holes, cavities, folds and glass fiber ends projecting from its surface). Such surface imperfections will impair the quality and appearance of the lacquer coating. The surface finish layer 23 has been found to effectively cover any surface imperfections. In this regard it has also been found that a suitable scrim material contributes to this surprising effect. The composition of the scrim is important to the effectiveness with which visibility and discernibility of the imperfections are reduced. Without reinforcing scrim in the PVC-film holes and cavities would still show in the finished product, and would not satisfy the aesthetic applications for which the product according to the invention is intended and suitable.

The finished sheet material product is thin and lightweight, and can have a weight of about only 1.2 kg/m², and a thickness of about 1 millimeter.

Accordingly a composite sheet material 1 is described that comprises a glass fiber reinforced thermoplastic substrate 3 with first and second sides, a reinforced film 23 on the first side of the glass fiber reinforced substrate 3, and a layer of paint 24 applied to an exposed surface of the reinforced film 23. The glass fiber reinforced thermoplastic substrate 3 has three layers 7, 9, 11 of wound glass fiber filaments 21 consolidated and fused in a thermoplastic resin matrix 22. The composite sheet material 1 thereby is useful in constructing hail-proof roof paneling.

It is thus believed that the operation and construction of the present invention will be apparent from the foregoing description and drawings appended thereto. For the purpose of clarity and a concise description features are described herein as part of the same or separate embodiments, however, it will be appreciated that the scope of the invention may include embodiments having combinations of all or some of the features described. It will be clear to the skilled person that the invention is not limited to any embodiment herein described and that modifications are possible which may be considered within the scope of the appended claims. Also kinematic inversions are considered inherently disclosed and can be within the scope of the invention. In the claims, any reference signs shall not be construed as limiting the claim. The terms ‘comprising’ and ‘including’ when used in this description or the appended claims should not be construed in an exclusive or exhaustive sense but rather in an inclusive sense. Thus expression as ‘including’ or ‘comprising’ as used herein does not exclude the presence of other elements, additional structure or additional acts or steps in addition to those listed. Furthermore, the words ‘a’ and ‘an’ shall not be construed as limited to ‘only one’, but instead are used to mean ‘at least one’, and do not exclude a plurality. Features that are not specifically or explicitly described or claimed may additionally be included in the structure of the invention without departing from its scope. Expressions such as: “means for ...” should be read as: “component configured for . . . ” or “member constructed to . . . ” and should be construed to include equivalents for the structures disclosed. The use of expressions like: “critical”, “preferred”, “especially preferred” etc. is not intended to limit the invention. To the extend that structure, material, or acts are considered to be essential they are inexpressively indicated as such. Additions, deletions, and modifications within the purview of the skilled person may generally be made without departing from the scope of the invention, as determined by the claims.

1. Composite sheet material comprising:
a glass fiber reinforced thermoplastic substrate having first and second sides;
a reinforced film on the first side of the glass fiber reinforced substrate; and
a layer of paint applied to an exposed surface of the reinforced film.

2. Composite sheet material as in claim 1, wherein the glass fiber reinforced thermoplastic substrate has three layers of wound glass fiber filaments consolidated and fused in a thermoplastic resin matrix.

3. Composite sheet material as in claim 2, wherein the glass fiber filaments are in a tensioned state.

4. Composite sheet material as in claim 2, wherein the glass fiber filaments are arranged next to one another.

5. Composite sheet material as in claim 2, wherein the glass filaments are continuous fibers in twisted yarns.

6. Composite sheet material as in claim 2, wherein the continuous glass filaments are wound E-glass filaments.

7. Composite sheet material as in claim 2, wherein the layers of glass filaments are stacked in three crosswise plies.

8. Composite sheet material as in claim 7, wherein the glass filaments of the three crosswise plies are in a 0-90-0 degree cross-ply.

9. Composite sheet material as in claim 7, wherein each of the plies has a thickness between 0.3 and 0.5 mm.

10. Composite sheet material as in claim 2, wherein the thermoplastic resin matrix is a poly-ethylene terephthalate (PET).

11. Composite sheet material as in claim 10, wherein the poly-ethylene terephthalate is a poly-ethylene terephthalate glycol copolymer resin (PETG).

12. Composite sheet material as in claim 1, wherein the reinforced film is a vinyl film.

13. Composite sheet material as in claim 1, wherein the reinforced film is a PVC film having an embedded scrim fabric as reinforcing element.

14. Composite sheet material as in claim 13, wherein the scrim fabric is visible as a surface pattern on the exposed surface.

15. Composite sheet material as in claim 1, wherein the reinforced film has a thickness of 410 μm.

16. Composite sheet material as in claim 1, wherein the layer of paint is a durable UV-curing paint coating.

17. Composite sheet material as in claim 1, wherein the layer of paint has a coating thickness of 30 μm.

18. Method of manufacturing a composite sheet material comprising at least the steps of:
providing a glass fiber reinforced thermoplastic substrate having first and second sides;
applying a reinforced film on the first side of the glass fiber reinforced substrate; and
applying paint to an exposed surface of the reinforced film.

19. Method as in claim 18, wherein the glass fiber reinforced thermoplastic substrate has a PETG binder matrix, and the reinforced film has a PVC binder matrix, and wherein the reinforced film is thermally laminated directly to the glass fiber reinforced thermoplastic substrate.

20. Recreational vehicle or trailer having as an outer body panel, and preferably at least as a roof panel, the composite sheet material of claim 1.

21. Recreational vehicle or trailer having as an outer body panel, and preferably at least as a roof panel, the composite sheet material as obtained in accordance with claim 18.
